(19) United States
(12) Patent Application Publication
(10) Pub. No.: US 2003/0088482 A1
(43) Pub. Date: May 8, 2003

(54) Grouping and pooling of economic and design resources relating to products and services

(76) Inventor: J. Seth Blumberg, Washington, DC (US)

Correspondence Address: Charles Berman, GREENBERG TRAURIG, LLP, Suite 400E, 2450 Colorado Avenue, Santa Monica, CA, 90404, US

(21) Appl. No.: 10/322,151

(22) Filed: Dec. 17, 2002

Related U.S. Application Data
(63) Continuation-in-part of application No. 09/694,276, filed on Oct. 24, 2000.

(51) Int. Cl. G06F 17/60

(52) U.S. Cl. 705/26

(57) ABSTRACT

A system for computerized management of products and services by pooling and grouping respective customers and involving these customers in the design and purchase of products or services. Using the Internet potential customers facilitate the design and purchase by volume of products to be manufactured or supplied by a producer. The criteria for the products or services are set by voting of members of the pool or group and the pool can determine the appropriate price and design criteria for products or services.

### RELATED PATENT AND APPLICATION

This application relates to U.S. Pat. No. 6,240,415 and U.S. patent application Ser. No.09/694,276 filed Oct. 24, 2000 and entitled CORPORATE AND ENTERTAINMENT MANAGEMENT INTERACTIVE SYSTEM USING COMPUTER NETWORK. The contents of that patent and patent application are incorporated by reference herein and this application is a continuation in part of the pending application.

### BACKGROUND OF THE INVENTION

This invention relates to management system, in particular it relates to a system for facilitating group decisions and for facilitating the pooling of economic resources.

It is notoriously difficult to economically effect the efficient decision making in designing and purchasing of different products and services. It is also difficult to effect cost-effective purchasing of such products and services.

This invention is concerned with providing a system, means, and method for facilitating the grouping and pooling of resources to achieve efficient design criteria relating to products and services and to facilitate efficient and low cost purchasing of products and services using the ability and power of the group or pool approval through a computer network.

### SUMMARY

This invention involves the use of an apparatus, the Internet, along with data files interacting according to the method and system of this invention.

There is a method of facilitating group or pooled decisions by multiple different potential customer participants about a product or service design of a supplier. There is a central database relating to design criteria of the product or service. Communication is effected through a data communication network between a central database processing resource and multiple remote participants.

The method comprises making available to the remote participants, via a communications link the remote participant being selectively a potential customer, the design criteria associated with a product or service. There is transmitted to the remote participants via the communications link wherein the remote participants are authorized to access the database, the designated design data from the database. A selection of the design criteria from the multiple potential customers is obtained, and multiple customer participants participating in creating collectively the product or service with the supplier.

An access request message from the remote participant is sent via a communications link, and the communications link is selectively a computer network, preferably including the Internet. The remote participant decides and communicates on at least one of the design criteria of the product or service. After verification of access to the database is authorized, a remote participant responds to the central database thereby to participate a decision relating to the product or service.

Periodic updating of the database with current design data about the product or service and permitting a remote participant to respond to the central database is possible thereby to participate in a decision relating to the product or service.

Analyzing the decisions relating to the product or service, and providing the report to remote participants based on the analysis the data of the product or service, and permitting remote participants to respond to the central database thereby to participate in a decision relating to the product or service is possible.

Controlling access to the central database resource, and wherein data in the database is accessible to selected multiple remote participants, and permitting a remote participant to respond to the central database thereby to participate in a decision relating to the product or service is possible.

Combining additional design data of the product or service with prior data of the product or service is possible thereby to permit an analysis of a modified design of the product or service. This permits a remote participant to respond to the central database thereby to participate in a decision relating to the product or service.

This permits management by a remote participant of a product or service by facilitating group or pooled decisions by multiple different potential customer participants about a product or service design of a supplier.

A system for facilitating group decisions by customers about a decision to purchase a product or service meeting designated design criteria is provided. There is a computer network, preferably including the Internet, having design criteria relating to a product or service. Designing the product or service is according to a predetermined level of votes received for different criteria of the product. Customers commit funds to purchase the product or service in terms of the decided design criteria.

The system including means for applying funds from a credit card or other payment or finance service through a banking source associated with the sale of the product or service. Funds relate to the product or service thereby permitting a product with design criteria to subsequently be manufactured according to the selected design criteria and sold according to those criteria.

The system of facilitating or grouping or pooling of resources in the purchasing or investing in the manufacture, marketing and sales of a product or service comprises opening an offer to potential customers for the product or service. Potential customers input into the selected product or service design or manufacture. A supplier receives criteria associated with the product and service. The potential customers commit funds for the purchase of a product or service designed by the group or pool of customers. The supplier receives the funds as a consequence of the pooled or grouped input and commitment of funds as a consequence of the pooled or grouped transaction.

A software program and a logic architecture enables people from any location in the world with access to the Internet or other computer communication network to receive and transmit information from a database on which to determine their decisions in relation to products, services and purchasing.

The funds for the products, services or purchasing may be raised by proceeds from participants in the purchase of services or products.

Periodically the database is updated with at least one of the historical or current data about the products, services or purchases. Reports of the products, services, and the steps between design, manufacture and purchase are stored in the central database processing resource.

Access to the central database processing resource is controlled wherein data in the database is accessible to selected multiple remote parties, in encrypted form if necessary.

Communicating between a remote party and the central database processing resource through a computer network includes providing credit card or password information of the remote user prior to providing the data, and data is transferred to the remote user after charging a credit card or other financial account for such data. Monies can be transferred electronically via a telecommunications line between respective financial entities related to the remote party and to an operator of the central database.

The invention is also directed to product or service management by multiple remote participant s comprising of relating to a current database of a product, service or purchase situation through data communication between a central database processing resource and at least one remote participant. The remote participant accesses the database and accesses designated data from the database. The data in the database includes selected data relating to the product or service with the current data related to the product or service situation. A report is compiled from the accessed database, the report including the data of the situation. This is then transmitted to the remote participant.

### BRIEF DESCRIPTION OF THE DRAWINGS

FIG. 1 is an overall view of a web-based system to provide access to a database management system of a business database in relation to the Internet.

FIG. 2 is a graphical illustration of a computer network, namely the Internet.

FIG. 3 is a block diagram of an exemplary computer system for practicing various aspects of the invention.

FIG. 4 is a view of a browser for the database management system for accessing the product, service and purchase database of the invention.

### DETAILED DESCRIPTION OF THE PREFERRED EMBODIMENT

The present invention will now be described in detail with reference to a few preferred embodiments thereof, as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order to not unnecessarily obscure the present invention.

Overall System

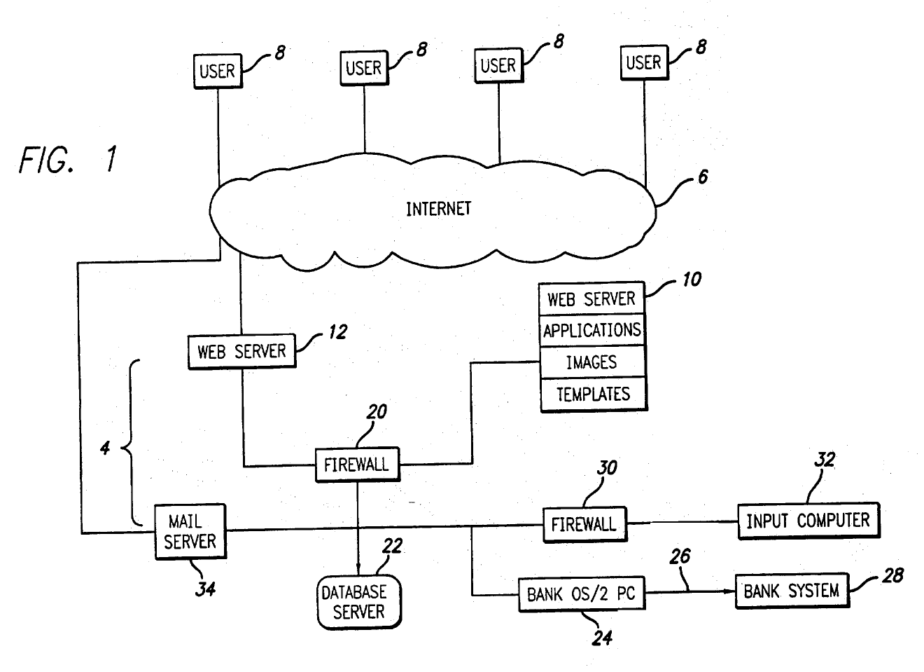

FIG. 1 is an overview of the web-based system to provide access to the invented database management system. With this system multiple users, for instance, remote users 8, access the web site 4 using the Internet 6. Each of the users 8 has a computer terminal with the appropriate software for accessing Internet. The users 8 may be unknown to the web server computers 10 and 12. Each user 8 is allowed to browse the web site and explore how the system functions.

There are several aspects to maintain security of information maintained in the database server 22 and a banking system 28. A firewall 20 prevents any user 8 from accessing any of the components behind the firewall 20. In this way the users 8 have access to the web server computers 10 and 12, but only have access to the database server 22 through the firewall 20. The database server 22 maintains, among other things, various database fields with respect to each of the profiles of subject employees, shareholders, directors and other pertinent information of a subject and other related groups and/or competitors. The database 22 maintains the services with a designation associated to determine what data can be browsed by the users 8. Each of the web server computers 10 and 12 allow users 8 to view subject and group categories and actual services and data products which are available from the database.

The web server computers 10 and 12 can be identical and can be duplicated as additional load or growth on the system occurs. The web server computers 10 and 12 share the responsibility for servicing the users of the site. This arrangement provides for expandability of the system by merely adding additional web server computers as necessary.

When the system requires payments for access, data, products or services, the system preferably includes an appropriate computer terminal 24 for interfacing with independent financial institutions which are connected on-line via the serial connection 26 to the financial institution computers 28. This allows automatic real time confirmation of the access of data, services, and products.

Once a user requires access to a product or service, the user goes through an identification or registration process and the exchange of financial information to allow for credit or debit card payment of the access, data or purchase. This is verified, confirmed and authorized by the appropriate bank system institution 28. Confirmation of the access, purchase or deposit of data, or a service is made by a mail server 34 which sends an E-mail to the user 8 confirming the purchase or deposit. The mail server 34 allows for mail to be received and sent out. Security of the various databases is maintained. Alert messages are generated when an unauthorized access is attempted. Verification messages, authorization messages and confirmation messages are generated as appropriate.

The database server 22 is also designed to interact with an input computer 32 operated by a central database processing resource (CDPR). A firewall 30 serves to prevent unauthorized access to the database server 22 or to the input computer 32. The input computer 32 can input profile data and other data to the database, after appropriate access and/or passwords are entered into the system. Similarly, users 8 through their own computers can use appropriate access codes and passwords to input data to the database server 22. This is tightly controlled for security reasons. The data may only be added to an independent sub-database of the data server 22, and only after scrutiny by the CDPR operator of the database through input computer 32, will this data from users 8 be subsequently added to the main database server 22.

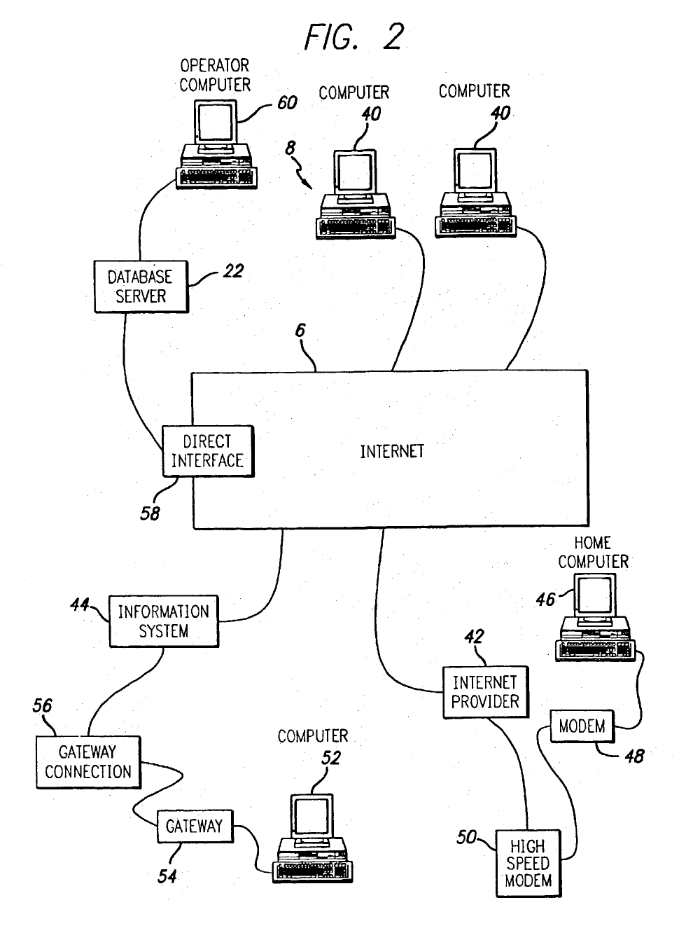

FIG. 2 is an illustration of the Internet and its use in the system of the invention. The Internet 6 is a network of millions of interconnected computers 40 including systems owned by Internet providers 42 and information systems 44 such as America Online (TM). Individual or corporate users may establish connections to the Internet in several ways. A user on a home PC 46 may access data, purchase or access an account through the Internet provider 42. Using a modem 48, the PC user can dial up the Internet provider to connect to a high speed modem 50 which, in turn, provides a full service connection to the Internet. A user 52 may also make a somewhat limited connection to the Internet through a system 20 that provides all Internet gateway connection 54 and 56 to its customers. The database 22 is also connected into the Internet 6 through an appropriate modem or high speed or direct interface 58. The database 22 is operable and maintained by the CDPR operator computer 60. Users of the databases of the invention would access the Internet in an appropriately selected manner.

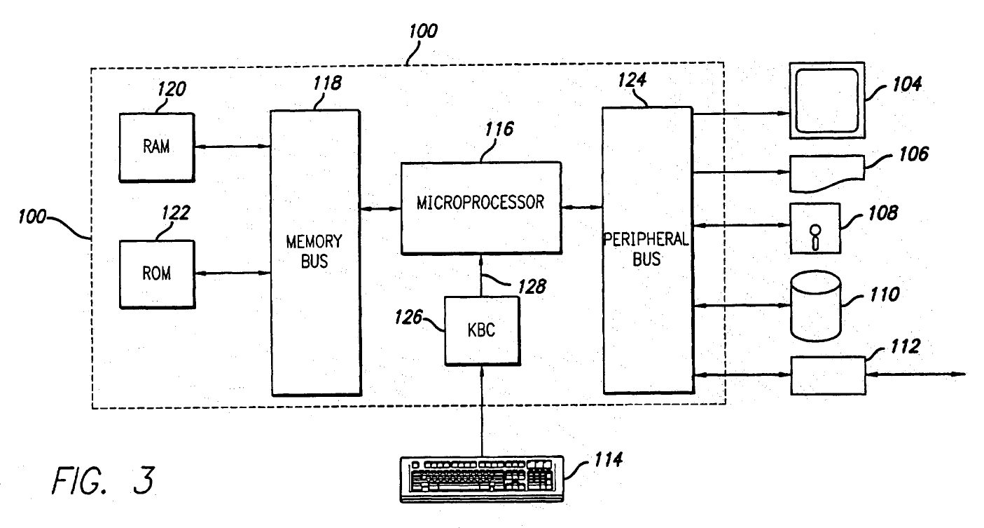

FIG. 3 is a block diagram of an exemplary computer system 100 for practicing various aspects of the invention. The computer system 100 includes a display screen or monitor 104, a printer 106, a disk drive 108, a hard disk drive 110, a network interface 112, and a keyboard 114. The computer system 100 includes a microprocessor 116, a memory bus 118, random access memory (RAM) 129, read only memory (ROM) 122, a peripheral bus 124, and a keyboard controller 126. The computer system 100 can be a personal computer, such as an Apple computer, e.g., an Apple Macintosh (TM), an IBM (TM) personal computer, or a compatible, a workstation computer, such as a Sun Microsystems (TM) or Hewlett-Packard (TM) workstation, or some other type of computer.

Microprocessor 116 is a general purpose digital processor which controls the operation of computer system 100. Microprocessor 116 can be a single-chip processor or can be implemented with multiple components. Using instructions retrieve from memory, the microprocessor 116 controls the reception and manipulation of input data and the output and display of data on output devices.

Memory bus 188 is used by the microprocessor 116 to access RAM 120 and ROM 122. RAM 129 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output, and storage devices used by computer system 10. These devices include the display screen 104, printer device 106, disk drive 108, hard disk drive 110, and network interface 112. The keyboard controller 126 is used to receive input from the keyboard 114 and send decoded symbols for each pressed key to microprocessor 116 over bus 128.

The display screen or monitor 104 is an output device that displays images of data provided by microprocessor 116 via peripheral bus 124 or provided by other components in computer system 100. The printer device 106 when operating as a printer provides an image on a sheet of paper or a similar surface. Other output devices such as a plotter, typesetter, etc. can be used in place of, or in addition to the printer device 106.

The disk drive 108 and hard disk drive 110 can be used to store various types of data. The disk drive 108 facilitates transporting such data to other computer systems, and hard disk drive 110 permits fast access to large amounts of stored data.

Microprocessor 116 together with an operating system operate to execute computer code and produce and use data. The computer code and data may reside on RAM 120, ROM 122, or hard disk drive 120. The computer code and data could also reside on a removable program medium and loaded or installed onto computer system 100 when needed. Removable program mediums include, for example, CD-ROM, PC-CARD, floppy disk and magnetic tape.

The network interface circuit 112 is used to send and receive data over a network connected to other computer systems. An interface card or similar device and appropriate software implemented by microprocessor 116 can be used to connect computer system 100 to an existing network and transfer data according to standard protocols. As such, the computer system is connectable through an interface device with the Internet 6.

Keyboard 114 is used by a user to input commands and other instructions to computer system 100. Other types of user input devices can also be used in conjunction with the present invention. For example, pointing devices such as a computer mouse, a track ball, a stylus, or a tablet can be used to manipulate a pointer on a screen of a general-purpose computer.

The present invention in relation to database management of data can also be embodied as computer readable code on a computer readable medium. The computer readable medium is any data storage device that can store data which can be thereafter read by a computer system. Examples of the computer readable medium include read-only memory, random-access memory, magnetic data storage devices such as diskettes, and optical data storage devices such as CD-ROMs. The computer readable medium can also be distributed over network coupled computer systems so that the computer readable code is stored and executed in a distributed fashion.

Specific System

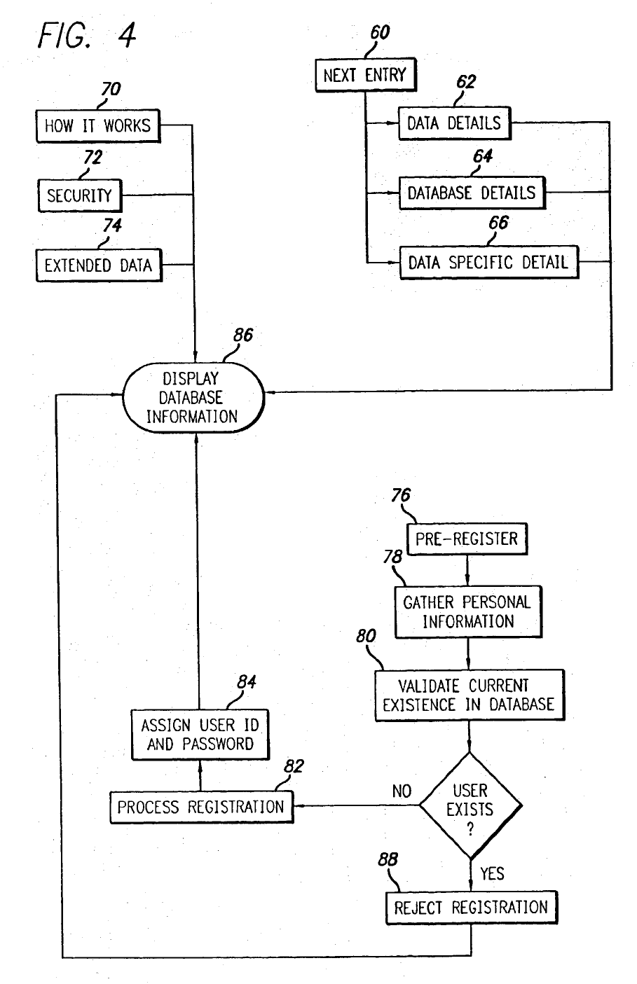

FIG. 4 illustrates a browser system for use with the database system of the invention. A browser goes through a number of preliminary screens and logic steps, and reaches a screen 60 entitled “Next Entry”. This screen provides data details or information generally indicated as 62. Clicking on any of these categories allows the user to review database details 64, data specific details as generally indicated by 66. In this way, the user can index through a number of screens to get information regarding the different databases of the system. In addition, clicking on any of the triggers 70, 72, 74 and 76 is possible. These correspond to HOW IT WORKS, SECURITY, EXTENDED DATA and PRE-REGISTRATION. Clicking on trigger 70 provides the user with information on how the process works, explains the system, and provides details on how the user can participate in the database and obtain data or input data. Clicking on trigger 72 provides details regarding security of the system and automatic payment. In some cases, products and services are offered with extended data and clicking on trigger 74 which can provide details of the extended data and explains that this may only be available on certain services or products.

Trigger 76 allows a user to pre-register and obtain user ID number. This ID number is combined with financial information retained in the database in an encrypted form. The pre-registration trigger 76 follows with step 78 which is to gather personal information such as credit card number and expiry date to allow for automatic payment. Step 80 is to validate a current existence in the database, if this occurs. With a negative answer, the user is directed into a registration process indicate as 82. A user ID is assigned and a password is entered. This information is maintained in a portion of the database 22. At 84 the user is provided a screen identifying the user ID at screen 86. If the user already exists, the registration process is rejected at 88 and the user is advised of the information at the display 86. The screen at 86 would also represent the information which is available in the database 22.

Example Scenarios

This invention comprises a method of a group or pool of people joining together to make a group business decision relating to the product or service, such as a purchase decision, by voting over a computer network, such as the Internet to create a set of criteria for a product offering that is not currently available on the market. A group or pool of people can make a decision to purchase a product in bulk by voting on line and create a product that is not otherwise available at the price desired by the individuals in the group or with the set of design specifications not currently available on the market desired by the group. Through the use of a computer network such as the internet, any group of individuals can join together in real time to make decisions about a particular product that ends up with the product being purchased by the members of the group or some individuals members of the group can invest in a business venture to market and sell the product designed and specified by the group which product has market advantages that would not otherwise be available.

There are several existing problems in the marketplace solved by this invention.

For example, currently in the marketplace, liquid crystal display (LCD) television sets have the advantage over typical television sets with picture tubes in that the LCD televisions are very thin. The LCD televisions are typically a more preferable television than picture tube televisions because they take up less space in the room.

The LCD televisions currently available on the market are several times more expensive than regular televisions. As a result there is a vicious cycle whereby the economies of scale have not developed for. LCD televisions because the LCD televisions are too expensive. Additionally, LCD televisions are only available in the marketplace in either very small sizes or very large sizes probably because those niches are easier to break into with the existing competition of picture tube televisions.

As a result of this current market situation, there is no product offered in the public marketplace of a LCD television that is around the 25-inch size range. Yet the general marketplace would greatly prefer a 25-inch LCD television if the price was more competitive with the typical 25 inch picture tube television.

The vicious cycle an economy of scale can be created whereby a new product can be offered: a less expensive LCD television with certain specified features including a 25 inch size and a myriad of other specified and voted upon quality specifications.

The prospective purchasers can also specify the required terms of the warranty by voting on different suggested terms and legal language.

For example, the prospective purchasers could create a deal term for the product warranty whereby the group votes to retain a certain amount of money to insure repairs.

Certain buyers/and investors who get in early may vote to invest nonrefundable money in the project which could be used, as approved by vote, for legal fees, advertising, or other optional costs of increasing the potential of the project. Those initial investors may have some preferential treatment voted and approved for them as additional incentive to become an early investor.

The individuals vote and agree to use their credit card, or other payment method, with a computer network, such as the internet, to pay for and cause the previously unavailable product such as the 25 inch LCD televisions, for example, to be built as specified using the invention and the ensuing agreed upon vote through the invention and the computer network which then automatically causes the process to be underway and performed whereby a specific number of a previously unavailable specific product to be paid for by all individuals in the group who so agree and all the presold televisions to begun to be built according to the voted upon specification, and then the finished products to be sent to each individual who prepaid for each LCD television. Alternatively, some individuals in the group could invest in the entire project but not necessarily purchase the product. The investors could have the option through the use of the invention to obtain some precisely specified number of units of the finished product as collateral for their investment should the investment not pay the investor back her or his investment on the terms agreed to also through the use of the invention with a vote over the computer network. The terms of the investment (just like the price point and the product design specifications) through the use of the invention can be created and agreed upon by vote over a computer network.

Each business decision of the group can be voted upon until there is a large enough number of buyers and/or investors agreeing to all the specifications and the desired price point to create an economy of scale with the largest number of presold units and/or investors. During the process the group can vote to price out the specified product with different factories and manufacturers that normally produce such products. At the point where a manufacturer's price is equal or less than the voted upon and agreed to price, then the purchasers' credit cards, or other financial instrument, would be charged for the specifically designed television to be purchased as agreed to through the use of the invention. Similarly, investors credit cards or other financial instrument would be used to collect the investors money and the products, for example televisions, that are paid for by the investors will be marketed for sale to the general public as well as the list of other participants in the design who did not agree to final specifications of the televisions that were actually produced.

There is formed a pool or group of people interested in purchasing or investing in the manufacture, marketing and sales efforts of a specific product. A product is designed with specific design criteria chosen through the invention during the course of the design and approval process. A product is manufactured with a large number of units presold so that an economy of scale is created which allows a significantly lower price point than would be feasible without the invention. An economy of scale is created because some crucial and normal market risks are removed. For example, the risk of a low speed of sales and the risk of insufficient investor interest is removed by the invention.

The terms of investment by the prospective investors and for future prospective investors is created. The investors interest may wax and wane during the process of formation of the business venture of designing, manufacturing, and building the product. The prospective investors vote and decide the price for which they are willing to buy a certain quantity of televisions and the price at which they are willing to sell the televisions that they have bought. The investors can always exercise their option of taking their collateral of a certain number of television sets and sell them or do with them as they want.

Many different product design projects could be going on simultaneously. So if a prospective purchaser is interested in a larger or smaller television or some other design specification, then she or he could become interested in an alternate project with a different group of prospective purchasers and investors. Alternatively a prospective purchaser could start a new project through the use of the invention.

An otherwise unavailable product, for example a 25 inch LCD television, at an otherwise unattainably low price is designed, manufactured, purchased and delivered to a number of purchasers. Optionally a group of investors would have the opportunity to invest in such project(s).

In some cases, via the system, the marketplace may vote to demand a guarantee of the opposite of the norm, for example, a decrease in the quantity or volume of product being produced and an increase in price.

For example, artwork is more valuable when the quantity of a specific piece is lower. In other words, via the invention, an artist can be paid a higher amount of money to produce a one of a kind piece, instead of producing the piece in higher quantities. Alternately, via the invention, the artist may be paid a higher amount of money per copy to produce a more limited edition of a piece of art.

Generally in the market place, a vicious economy is created by the confluence of a high price of the cost of production of new product and the lack of ability to guarantee an economy of scale to the businessman who is producing the product. Typically, the businessman does not want to risk investing a large amount of money to speculatively manufacture a large volume of a newly designed product because there is no guarantee that the large number of units will sell quickly enough even at a lower price to avoid the prohibitive costs of long term storage and long term interest carry costs.

The combination of a price point that is too high and the high risk that if a high volume of a product is manufactured and kept in inventory will not sell quickly enough creates a vicious cycle that causes unavailability of products or unavailability of a price point at a point in time when the product would easily sell if the price was significantly lower. At this time through the use of the invention, the 25-inch LCD TV would be able to be produced with less risk of slow sales.

The way the market functions currently, the 25 inch LCD TV might not sell at a high volume 5 years in the future when there is a newer technology that is superior—so the original pioneers of the 25 inch LCD TV might never reach the levels of success that they could through the use of this invention.

Without this invention, if a high volume of a product is manufactured and sales are not speedy, then there is a high interest carry cost over time and a high storage and maintenance cost. Typically, an interest carry cost must be a significant element of the budgeting process of production. Additionally, when a high volume of a product is manufactured in order to create an economy of scale to lower per unit manufacturing costs, if sales are not speedy enough, then there will be a large cost for storage of inventory, shipping multiple times before the product gets to the customer, and cost of maintaining and cataloguing and keeping the inventory insured and secured. All of these risks and concomitant expenses are typically budgeted into the cost and sales price of a product. This invention allows those costs to be minimized to the point that products can be produced that would otherwise not be viable in the marketplace. Currently new product designs and products which have too high of a risk of slow sales are marketed in a version that is low volume with a high priced, high volume with low quality, or offbeat specialty-niche markets such as 10 inch LCD televisions for kitchens that can be hidden and fold out from underneath a wall cabinet.

One advantage provided by the invention is that the consumer can take an active role in limiting the risks of the manufacturer and thus through the use of the invention the consumer lowers the cost of the product while maintaining or even improving the quality of the product.

In another example of the myriads of possibilities of the use of this invention, a subdivision home builder has a difficult task to lower his interest carry costs on: inventory of land, model houses in different subdivisions, and the length of time of construction of a home ordered by a customer.

The customers can pool their purchasing power through the use of the invention and determine the specifications and price of the home that each member of the group is willing to purchase.

Through the use of the invention the buyers can place a down payment on the purchase of, for example, their homes. The invention also creates a time pressure on the purchaser to either commit to a putting down a monetary deposit or risk losing being one of the group in cases where the number of copies produced is limited.

Through the use of the invention, homebuilders, as an example of many products and services that can benefit through the use of the invention, can qualify the location of their subdivision within the criteria of acceptable locations described by the group of purchasers and then the builder can competitively offer a specific product at a specific price.

The builder can prove his ability through the use of the invention by publishing subcontractor and supplier contracts.

Over the Internet or other computer network and through the use of the invention, the group of purchasers who are preassembled can vote to approve the location of a subdivision offered by a builder and later the group can approve the price and design specifications of the homes to be built.

The builder has an opportunity for “found money” or business profits that the builder would not have otherwise had an opportunity to make. The money that the builder saves due to lower interest carry costs and other lower costs as a result of a reduction of various risks can be passed on to the purchasers.

Multiple builders may have multiple model homes all located at one central place in the country for prospective homebuyers to choose from. Homebuilders could pass significant cost savings onto the homebuyers due to dispensing with the need to build models, and airfare for buyers could be deducted from a purchase or a certain number of airfares for prospective purchasers could be paid for by the monetary deposits of buyers and investors.

Through the use of the system, the builder and/or the group of homebuyers can join other buyer groups that are buying any product or service, for example refrigerators. As a result, the refrigerator does not have to be purchased by the homebuilder because the group of homebuyers, for example, buys the refrigerators themselves. Through the economy of scale and the more fluid market created via the invention, the homebuyers can potentially get a lower price on a higher quality refrigerator than the builder would be able to supply for the homes.

Similarly, many products for which the builder does not have enough purchasing power or leverage can be bought instead by the purchaser group via the invention. Of course, many of the refrigerator buyers in the refrigerator buyer group may not be buying a new home; they may simply be replacing their old refrigerator in their existing home. Diverse groups of buyers and sellers can be joined together for the mutual benefit of everyone in the group.

Home buyer groups from all over the world can join together to create economies of scale for many products required, for example, for a new home such as: hot water heaters, air conditioning units, gas fired heating system furnaces, copper piping, electrical conduit, lumber, drywall, concrete all subcontractor installation services, etc.

Beyond products, services can be purchased and sold through the use of the invention. For example, homebuyer services also can be purchased via the invention such as: mortgages, homeowner insurance, title company services, appraisal services, etc.

A group of homebuyers can all pool together to obtain currently unavailable mortgage services. The mortgage lender who financially prequalifies the home buyers could compete with other mortgage lenders on the whole subdivision of new homes and offer a permanent loan which can be used for the construction as well. Currently in the market, a homebuyer must obtain a construction loan and then after the home is completed the homebuyer must obtain a permanent mortgage. All sorts of new services can be offered, for example, the homebuyer can simply obtain one loan for both construction and permanent financing and thereby reducing costs.

Diverse groups of buyers and sellers can join together for mutual benefit. For example, homeowners may group together with other subdivisions to self-insure their homes.

As another example, a farmer whose farm is in a valuable location for development into a subdivision of homes may be able to strike an agreement along with a builder as a partner to presell homes in the future subdivision on the farm so that the farmer can realize a higher profit on his farm. Typically, a developer buys the farm from the farmer at a lower value because the developer must pay interest carry cost on the inventory of land. In the meantime the developer must spend a few years going through the subdivision design and permit process. When the streets are finally built, the developer can sell lots to merchant builders. Then the builders have the added costs of the developer's interest carry costs and their own interest carry costs on their inventory of land until the homes are built and sold.

Through the computer network these inefficiencies can be significantly reduced and the market can be made more fluid so that such costs are reduced and, for example, the homebuyers can pay a lower cost for their homes and obtain a higher quality home.

As another of a myriad of examples of products and services that may make use of in the telecommunications field, data communications field and information services field consumers must pay a high price because the risk of capital expenses of construction of infrastructure is high for the company offering the services. Through a computer network such as the Internet, a large group of consumers can greatly reduce the cost of infrastructure and cause the price point of the service to the customer to be greatly reduced. For example, the purchaser group could decide to put down nonrefundable deposits to pay for the infrastructure of telecommunication services in advance so that the data communications company providing a high speed internet service and telephone service would be able to provide the services at an extremely low price as approved by the purchasers and the data/telephone company would be able to provide a higher quality service, again as preapproved by the purchasers.

The purchasers could vote to put the costs of the data/telecommunications services for a certain number of years into their prequalified and preapproved mortgages. Some homebuyers in an area could agree to the addition of the data/telecommunication services to their mortgage while others do not. Via the computer network, there can be enough data/telecommunications purchasers in a surrounding area to compensate for individuals in a subdivision who do not buy that service.

Some portion of the group of purchasers of data and telecommunications services via the invention and through the use of a computer network such as the internet could also decide to be investors in the data/telecommunications business.

Business owners and purchasers can buy and sell any product or service with the advantages of increased market efficiencies and reduced risks.

Many other examples of the invention exist each differing from the other in matters of detail only. The invention is to be determined in terms of the following claims.

What is claimed is:

1. A method of facilitating group or pooled decisions by multiple different potential customer participants about a product or service design of a supplier and wherein there is a central database relating to design criteria of the product or service, and communicating through a data communication network between a central database processing resource and multiple remote participants, the method comprising the steps of:
a) making available to the remote participants, via a communications link the remote participant being selectively a potential customer, the design criteria associated with a product or service;
b) transmitting to the remote participants via the communications link wherein the remote participants are authorized to access the database, the designated design data from the database;
c) obtaining a selection of the design criteria from the multiple potential customers; and
d) the multiple customer participants participating in creating collectively the product or service with the supplier.

2. The method of claim 1 including sending an access request message from the remote participant via a communications link, and the communications link is selectively a computer network, preferably including the Internet, and wherein the remote participant decides and communicates on at least one of the design criteria of the product or service.

3. The method of claim 1, comprising the steps of verifying that the access to the database is authorized, and permitting a remote participant to respond to the central database thereby to participate a decision relating to the product or service.

4. The method of claim 1, including periodically updating the database with current design data about the product or service and permitting a remote participant to respond to the central database thereby to participate in a decision relating to the product or service.

5. The method of claim 1, including analyzing the decisions relating to the product or service, and providing the report to remote participants based on the analysis the data of the product or service, and permitting remote participants to respond to the central database thereby to participate in a decision relating to the product or service.

6. The method of claim 1, including controlling access to the central database resource, and wherein data in the database is accessible to selected multiple remote participants, and permitting a remote participant to respond to the central database thereby to participate in a decision relating to the product or service.

7. The method of claim 1, including the step of verifying that selected remote participants are authorized to access the database or selected data in the database, and permitting a remote participant to respond to the central database thereby to participate in a decision relating to the product or service.

8. The method of claim 1, including combining additional design data of the product or service with prior data of the product or service thereby to permit an analysis of a modified design of the product or service, and permitting a remote participant to respond to the central database thereby to participate in a decision relating to the product or service.

9. A method of management by a remote participant of a product or service by facilitating group or pooled decisions by multiple different potential customer participants about a product or service design of a supplier comprising the steps of:
a) making available to the remote participants, via a communications link the remote participant being selectively a potential customer, the design criteria associated with a product or service;
b) transmitting to the remote participants via the communications link wherein the remote participants are authorized to access the database, the designated design data from the database;
c) obtaining a selection of the design criteria from the multiple potential customers;
d) the multiple customer participants participating in creating collectively the product or service with the supplier;
e) receiving an access request message from a remote participant via a communications link the remote participant being selectively a potential customer;
f) transmitting an access enabling message to the remote participant via the communications link wherein the remote participant is authorized to access the database, the access enabling message permitting the remote participant to access the database and access designated data from the database related to the product or service;
g) compiling a report from the accessed database, the report including the data of the product or service;
h) transmitting the report of the data to the remote participant; and
i) wherein there is a hierarchy of remote users, different levels in the hierarchy having different weight for their respective decision, which decisions can be transmitted to the central database.

10. The system of claim 9 wherein the remote parties receive decisions from other remote participants.

11. The system of claim 1 wherein a controller of a central database receives at least one decision on a product or service, and wherein the decision is selectively made available to other remote users and a supplier, such that the remote users can selectively make decisions based on that decision, and selectively transmit decisions further to the central database.

12. A system for facilitating group decisions by customers about a decision to purchase a product or service meeting designated design criteria comprising providing over a computer network, preferably including the Internet, design criteria relating to a product or service, and designing the product or service according to a predetermined level of votes received for different criteria of the product; and permitting the customers to commit funds to purchase the product or service in terms of the decided design criteria.

13. A system as claimed in claim 12 including means for applying funds from a credit card or other payment or finance service through a banking source associated with the sale of the product or service whereby the committed funds relate to the product or service thereby permitting a product with design criteria to subsequently be manufactured according to the selected design criteria and sold according to those criteria.

14. A system of facilitating or grouping or pooling of resources in the purchasing or investing in the manufacture, marketing and sales of a product or service comprises:
a) opening an offer to potential customers for the product or service;
b) permitting potential customers input into the selected product or service design or manufacture;
c) permitting a supplier to receive criteria associated with the product and service;
d) permitting the potential customers to commit funds for the purchase of a product or service designed by the group or pool of customers;
e) permitting the supplier to receive the funds as a consequence of the pooled or grouped input and commitment of funds as a consequence of the pooled or grouped transaction.

15. A system as claimed in claim 14 including the facility for passing a financial down payment to the supplier of the product or services.

16. A system as claimed in claim 14 including sending an access request message from a remote customer via a communications link, and the communications link is selectively a computer network, preferably including the Internet, and wherein the remote customer decides and communicates on at least one of the design criteria of the product or service.

17. The method of claim 14, including periodically updating a database with current design data about the product or service and permitting a remote participant to respond to the central database thereby to participate in a decision relating to the product or service.

18. The method of claim 14, including analyzing decisions relating to the product or service, and providing a report to remote participants based on the analysis the data of the product or service, and permitting remote participants to respond to the central database thereby to participate in a decision relating to the product or service.

19. The method of claim 14, including controlling access to the central database resource, and wherein data in the database is accessible to selected multiple remote participants, and permitting a remote participant to respond to the central database thereby to participate in a decision relating to the product or service.

20. The method of claim 14, including combining additional design data of the product or service with prior data of the product or service thereby to permit an analysis of a modified design of the product or service, and permitting a remote participant to respond to the central database thereby to participate in a decision relating to the product or service.

21. The method system of claim 14 wherein remote parties receive decisions from other remote participants.

22. The method of claim 14 including a controller of a central database for receiving at least one decision on a product or service, and wherein the decision is selectively made available to other remote users and the supplier, such that the remote users can selectively make decisions based on that decision, and selectively transmit decisions further to the central database.

23. A method as claimed in claim 14 including permitting the purchase of a product or service meeting designated design criteria comprising providing over a computer network, preferably including the Internet, design criteria relating to a product or service, and designing the product or service according to a predetermined level of votes received for different criteria of the product; and wherein the customers commit funds to purchase the product or service in terms of the decided design criteria.

24. A method as claimed in claim 14 including applying funds from a credit card or other payment or finance service through a banking source associated with the sale of the product or service whereby the committed funds relate to the product or service thereby permitting a product with design criteria to subsequently be manufactured according to the selected design criteria and sold according to those criteria.
